(19) United States
(12) Patent Application Publication
(10) Pub. No.: US 2026/0332398 A1
(43) Pub. Date: Oct. 22, 2026

(54) METHODS AND SYSTEMS OF USING QUANTUM KEY DISTRIBUTION FOR SECURE USER AND DATA AUTHENTICATION

(71) Applicant: PQCEE PTE LTD, Singapore (SG)

(72) Inventor: Teik Guan TAN, Singapore (SG)

(21) Appl. No.: 19/107,594

(22) PCT Filed: Aug. 29, 2023
(86) PCT No.: PCT/SG2023/050591

§ 371 Date: Feb. 28, 2025

(30) Foreign Application Priority Data
Sep. 1, 2022 (SG) 10202250875T

(51) Int. Cl. H04L 9/08; H04L 9/32

(52) U.S. Cl. CPC H04L 9/0852; H04L 9/0819; H04L 9/3226; H04L 9/3271

(57) ABSTRACT

A system and a method for quantum-capable secure user and data authentication are provided. The system includes first and second communication devices and first and second key distribution modules. The first key distribution module is communicatively coupled to the first communication device for secure access thereto and the second key distribution module is communicatively coupled to the second communication device for secure access thereto. The first communication device and the second communication device enable quantum-safe messaging therebetween by lightweight post-quantum cryptographic communication between the first key distribution module and the second key distribution module. Also, the first communication device and the second communication device have established a pre-agreed secret password. In addition, the lightweight post-quantum cryptographic communication includes the first key distribution module and the second key distribution module establishing a shared random therebetween.

### PRIORITY CLAIM

This application claims priority from Singapore patent application Ser. No. 10202250875T filed on 1 Sep. 2022.

### FIELD

The present disclosure generally relates to quantum computing user and data authentication, and more particularly relates to methods and systems for using quantum key distribution for secure user and data authentication.

### BACKGROUND OF THE DISCLOSURE

Quantum Key Distribution (QKD) was first introduced using photons with different polarization as a means for two communicating parties to securely exchange a secret key. Using QKD, communicating parties can use the secret key for session encryption to achieve data confidentiality. This key distribution bypasses the need to rely on public key cryptography to perform key distribution and has been shown to be secure against quantum adversaries.

The application of QKD in encryption is widely known and is conventionally used to negotiate a random and secret value between two QKD modules. The secret value can then be used directly (e.g., using a Vernam one-time pad (OTP)) or indirectly (e.g., used as a master key for various key-exchange protocols such as IPSEC). Challenges for QKD are the lack of application use-cases beyond session data confidentiality and the need for specialized costly quantum equipment. While many devices have low resource limitations, such devices still have a need to defend against quantum capable adversaries. For example, many applications in Internet of Things (IoT) require authentication of both users and data in IoT communication, yet have low overhead limitations. Thus, the high equipment cost of QKD modules and the high computation and data overhead requirements required to use quantum cryptography makes QKD use impractical in quantum-based authentication for such overhead-restricted use-cases.

There is, therefore, a need for methods and systems for secure user and data authentication which overcome the drawbacks of present quantum-ready secure authentication systems and provides robust protection against quantum-capable attackers and low computational and data overheads for low-resource device communications. Furthermore, other desirable features and characteristics will become apparent from the subsequent detailed description and the appended claims, taken in conjunction with the accompanying drawings and this background of the disclosure.

### SUMMARY

According to at least one embodiment of the disclosure, a system for quantum-capable secure user and data authentication is provided. The system includes first and second communication devices and first and second key distribution modules. The first key distribution module is communicatively coupled to the first communication device for secure access thereto and the second key distribution module is communicatively coupled to the second communication device for secure access thereto. The first communication device and the second communication device enable quantum-safe messaging therebetween by lightweight post-quantum cryptographic communication between the first key distribution module and the second key distribution module. Also, the first communication device and the second communication device have established a pre-agreed secret password. In addition, the lightweight post-quantum cryptographic communication includes the first key distribution module and the second key distribution module establishing a shared random therebetween.

According to another embodiment of the present disclosure, a method for quantum-capable secure user and data authentication is provided. The method is provided in a system including a first communication device communicatively coupled to a first key distribution module communicatively and a second communication device communicatively coupled to a second key distribution module. The first communication device and the second communication device are communicatively coupled across a first communication path and enable quantum-safe messaging therebetween by lightweight post-quantum cryptographic communication between the first key distribution module and the second key distribution module. The method includes the first communication device and the second communication device establishing a pre-agreed secret password therebetween and the first key distribution module and the second key distribution module establishing a shared random therebetween via the lightweight post-quantum cryptographic communication.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts a diagram of Quantum Key Distribution (QKD) communication in accordance with the present embodiments.

FIG. 2 depicts a flow diagram of user authentication in accordance with the present embodiments.

FIG. 3 depicts a flow diagram of data authentication in accordance with the present embodiments.

FIG. 4 depicts real-world applications where digital signing authentication is and will be required, some of which involve use of low-resources devices.

And FIG. 5, comprising FIGS. 5A and 5B, depicts an exemplary QKD module for use in an entanglement-based QKD system, wherein FIG. 5A depicts the structure of the conventional exemplary QKD module and FIG. 5B depicts a less complex structure of the QKD module for use with low resource devices in accordance with the present embodiments.

Embodiments of the disclosure disclose that elements in the figures are illustrated for simplicity and clarity and have not necessarily been depicted to scale.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description. It is the intent of present embodiments to present a novel usage of Quantum Key Distribution (QKD) to achieve secure user and data authentication. QKD can be used by communicating parties to exchange a random and secret key and to achieve data confidentiality. In accordance with present embodiments, QKD is combined with Learning Parity with Noise (LPN) into a simple and lightweight authentication protocol which is quantum-secure and not susceptible to a man-in-the-middle (MITIM) eavesdropping attack and can advantageously be used for remote user-password verification, device-to-device secure messaging and secure broadcasting with low computational and data overhead.

LPN is a post-quantum cryptographic system with low memory and computational requirements which makes it useful as a cryptosystem for low-resource devices. The Hopper-Blum (HB) protocol is an application of the LPN cryptosystem to allow two communicating parties to use a challenge-response method to authenticate each other. While HB is shown to be secure against passive attackers who cannot influence or change the challenge, it is insecure against active adversaries who can modify or fake the challenge. This has led to new variations of the HB protocol which, unfortunately, increase the number of messages, computational and data overheads, thus affecting LPN's attractiveness as a lightweight protocol for low-resource device communications. The combination of LPN with QKD in accordance with the present embodiments uses LPN to complement QKD in order to overcome several of the challenges faced by both systems and achieve novel use-cases for robust user and data authentication over a lightweight protocol.

While combining the use of post-quantum cryptography with QKD is not new, they are typically only done to augment QKD key negotiations and not to achieve new use-cases. For example, one conventional technique demonstrated experimentally how a post-quantum lattice-based digital signature scheme could be used to build an authenticated channel for QKD negotiations and enable data encryption to take place securely.

Communicating parties can use the secret key distributed by QKD for session encryption to achieve data confidentiality. QKD key distribution bypasses the need to rely on public key cryptography to perform key distribution and several QKD networks, spanning hundreds and thousands of kilometres in length, have been set up to measure and understand practical QKD capabilities and limitations.

LPN is a fundamental mathematical problem in modern cryptography which widely used to create secure encryption algorithms. LPN is based on representing secret information as a set of equations with errors, making it difficult for any bounded attacker to find the secret information. LPN is a promising post-quantum hardness assumption with parallels to the theory of error-correcting codes

The HB protocol is a vanilla construction of the LPN cryptosystem embodied in a challenge-response exchange between a Verifier and Prover. The challenge-response exchange includes four stages: a setup, a challenge, a response and a check-response. At the setup stage, the Prover and Verifier have a pre-agreed secret key s and s′, respectively, where s=s′. At the challenge stage, the Verifier generates a random challenge matrix C and this challenge matrix C is transmitted to the Prover. At the response stage, the Prover computes the response vector r=C·s⊕e, where e is a LPN noise vector which flips certain bits in the response r according to a pre-defined probability. The response vector r is sent to the Verifier. Finally, at the check-response stage, the Verifier computes a weight w=∥C·s′⊕r∥₁. If w is smaller than an acceptable authentication window, then the Verifier is convinced that the Prover knows the correct secret s. Otherwise, the authentication request is rejected.

All LPN matrices and vectors are of a binary (1 or 0) base. The secret key s, the noise vector e, and the response r are vectors. The challenge matrix C is a matrix, while the weight w is an integer value. The · operation represents the mathematical dot-product or matrix multiplication between a matrix and a matrix, or between a matrix and a vector. The ⊕ operation represents the mathematical XOR operation between a matrix and a matrix, or between a vector and a vector. And the ∥vector∥₁ operation represents the mathematical hamming weight (or number of non-zero entries) of a vector.

The advantage of the HB protocol is that it can be cheaply implemented as it only requires the use of AND and XOR gates on the Prover to compute the response r. Assuming that the challenge matrix C is random and not manipulated by an attacker, the HB protocol is a secure authentication against both classical and quantum adversaries. However, if an active attacker gets to modify C or create a fake C sent to the Prover, the secret value of s can be easily exposed. To defend against active attackers, new HB-based protocols such as HB+, HB++, HB # and SLPN add additional rounds of message exchange, checks and/or challenges which inadvertently increase the computational and data overheads but may not completely patch the vulnerability.

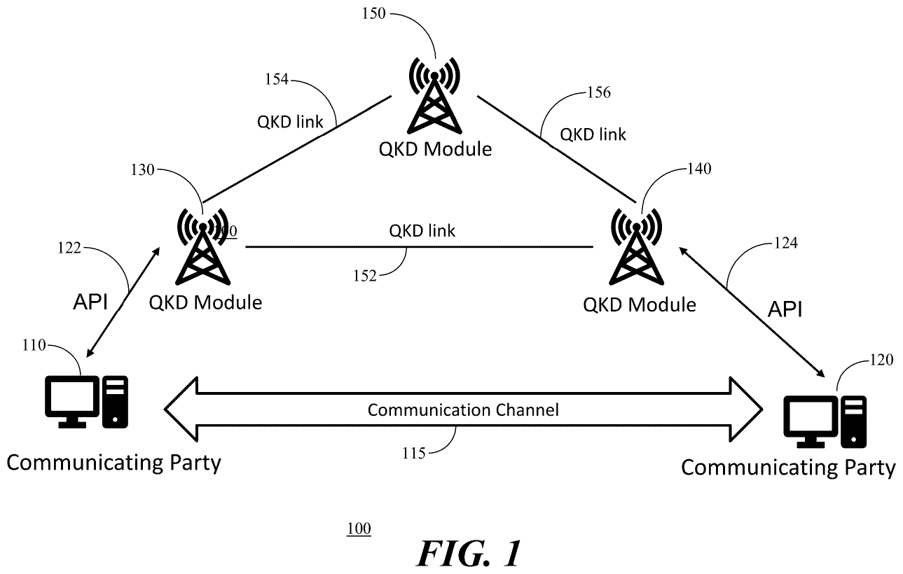

Referring to FIG. 1, a diagram 100 depicts an architecture for a use-case in accordance with the present embodiments including two or more communicating parties 110, 120, each having a communication device communicating across a communication channel 115. Each of the parties 110, 120 have Application Programming Interfaces (API) access 122, 124 to QKD modules 130, 140 which can perform QKD negotiations with each other and with other QKD modules 150 over a network of QKD links 152, 154, 156. While the QKD modules 130, 140, 150 are shown as separate entities, a possible embodiment may have one of the QKD modules be physically part of the communicating party's equipment. The present embodiments enable the communicating parties 110, 120 to authenticate each other while minimizing the transmission overheads across the communication channel 115 and still ensuring quantum-security. In accordance with the present embodiments, three assumptions for the architecture for secure user and data authentication are made. First, it is assumed that each party will have secure API access to a QKD module (e.g., API access 122, 124 to a QKD module 130, 140). The secure API access can be monitored, but cannot be modified. Next, it is assumed that the communicating parties 110, 120 who want to authenticate each other will have already established a pre-agreed secret password between them. The proving party will have to present this password during the authentication process and the verifying party will have to use the same password (or a derivation of the password) to check that the correct password was presented by the proving party. And finally, it is assumed that the QKD modules corresponding to both communicating parties (e.g., the QKD modules 130, 140 corresponding to the communicating parties 110, 120) are able to carry out a QKD negotiation protocol over a QKD link (e.g., the QKD link 152) to establish a shared random between the modules.

The architecture in accordance with the present embodiments advantageously supports user and data authentication in a lightweight, quantum-secure protocol. This is achieved by using QKD to negotiate the LPN challenge matrix C between the communicating parties 110, 120. Since the QKD protocol will generate a truly random value which cannot be directly influenced by either party, most of the lightweight HB protocol can beneficially continue to be used as-is without added rounds of message exchange and computational complexity. In addition, using QKD to generate the challenge matrix provides both a transmission advantage as well as a security advantage. The transmission advantage of using QKD to generate the challenge matrix as compared to the HB protocol is that the Verifier no longer needs to transmit the challenge matrix to the Prover. The security advantage of using QKD to generate the challenge matrix for LPN as compared to using QKD as a symmetric key encryption system is that even if a man-in-the-middle eavesdropper attack takes place between the QKD modules 130, 140, the attacker will not be able to retrieve the pre-agreed secret password utilized by the sending party.

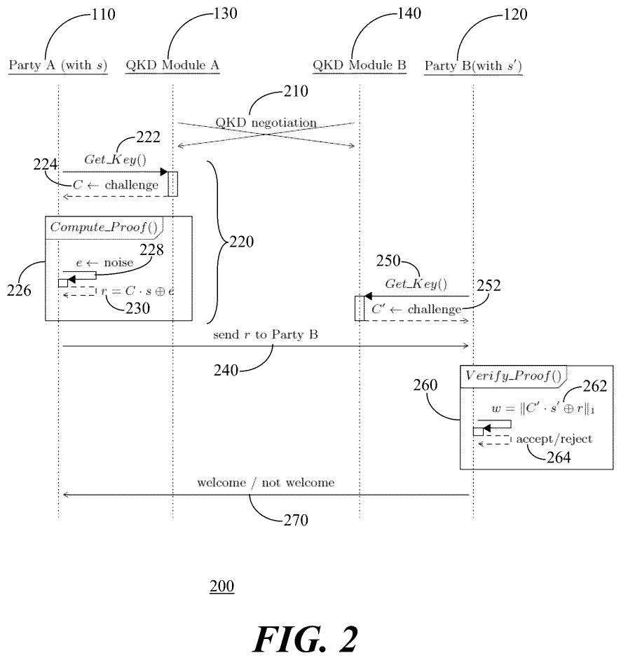

The objective for user authentication in accordance with the present embodiments is for the verifying party to be certain that the communication is happening with the proving party who knows the pre-shared secret password. Referring to FIG. 2, a flow diagram 200 depicts an exemplary user authentication process in accordance with the present embodiments. In the depicted example user authentication process, a Party A with QKD module A, such as the communicating party 110 having the corresponding QKD module 130, takes the role of the Prover and has a pre-agreed secret key s. A Party B with QKD module B (e.g., the communicating party 120 having the corresponding QKD module 140) takes the role of the Verifier and has a pre-agreed secret key s′. As discussed hereinabove, initially s=s′.

The user authentication process in accordance with the present embodiments, starts with the QKD modules carrying out QKD negotiations 210 over their links (e.g., QKD link 152). At the next step 220, Party A (i.e., the Proving party) computes the user authentication proof. The step 220 includes Party A connecting 222 to its QKD module A to obtain 224 the challenge matrix C and then to compute 226 a response cryptogram r by obtaining 228 randomly-generated noise e of a pre-defined probability and then calculating 230 the response vector r=C·s⊕e using the pre-shared secret s and the randomly generated noise e. The Party A then sends 240 the response cryptogram r to Party B, the verifying party.

Meanwhile, Party B connects 250 to its QKD module to obtain 252 the challenge matrix C′. Party B then verifies 260 the user authentication proof by using the received response cryptogram r, the challenge matrix C′ and the pre-shared secret key s′ to compute 262 weight w=∥C′·s′⊕r∥₁. Party B then determines 264 to accept or reject the communication based on a predefined acceptable authentication window for the value w (i.e., the user is authenticated if the computed weight w is within the acceptable authentication window, which is only possible if s=s′ and C=C′). If w is smaller than the acceptable authentication window, then Party B (the Verifier) is convinced that Party A (the Prover) knows the correct secret s and accepts the authentication request. Otherwise, the authentication request is rejected. Party B then sends 270 a welcome or not welcome response to Party A to either initiate communication (if welcome) or not initiate communication.

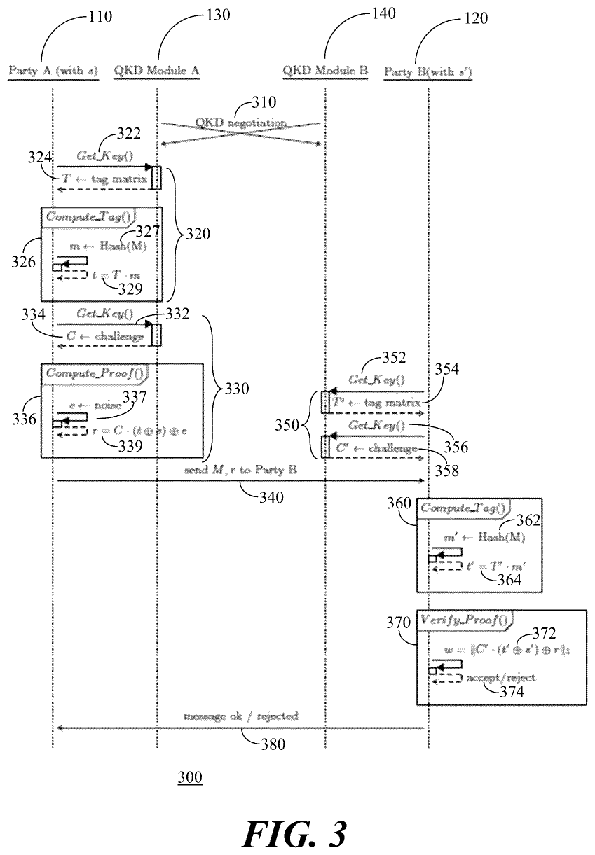

In addition to user authentication, the methods and systems in accordance with the present embodiments can be used for data authentication. The objective for data authentication in accordance with the present embodiments is for the verifying party to be certain that the data sent by the proving party who knows the pre-shared secret password has not been modified. Referring to FIG. 3, a flow diagram 300 depicts an exemplary data authentication process in accordance with the present embodiments. In the depicted example data authentication process (or ‘user plus data’ authentication process), a Party A with QKD module A, such as the communicating party 110 having the corresponding QKD module 130, takes the role of the proving party and a Party B with QKD module B (e.g., the communicating party 120 having the corresponding QKD module 140) takes the role of the verifying part with the QKD Modules A and B carrying out QKD negotiations over their QKD link (e.g., QKD link 152). Party A and Party B have pre-agreed secret keys s and s′, respectively, where initially s=s′.

The ‘user plus data’ authentication process in accordance with the present embodiments, starts with the QKD modules carrying out QKD negotiations 310 over their links (e.g., QKD link 152). Then, Party A computes 320 an authentication tag t by first connecting 322 to its QKD module to obtain 324 a tag matrix T and then compute 326 a tag vector t using a message M to be sent. A hash value m is determined 327 as m←Hash(M) and the tag t is calculated 329 as t=T·m. In one embodiment, the ‘user plus data’ authentication can be performed without a tag matrix T. In another embodiment, the tag vector t would be set equal to the hash value m (i.e., t=m).

Next, Party A computes 330 a ‘user plus data’ authentication proof by first connecting 332 to its QKD module to obtain 334 the challenge matrix C and then compute 336 a response cryptogram r using the tag vector t, the pre-shared secret key s and randomly generated noise e of a predefined probability obtained. The randomly generated noise e is obtained 337 and the response vector r is calculated 339 as r=C·(t⊕s)⊕e. Then, the message M (which can be further encrypted) and the response cryptogram r are sent 340 to Party B, the verifying party.

Meanwhile, Party B obtains 350 the tag matrix T′ and the challenge matrix C′ by (a) connecting 352 to its QKD module to obtain 354 the tag matrix T′ and (b) connecting 356 to its QKD module to obtain 358 the challenge matrix C′. Party B verifies the ‘user plus data’ authentication proof by first computing 360 a tag vector t′ using the message M received. A hash value m′ is determined 362 as m′←Hash(M) and the tag t′ is calculated 364 as t′=T′·m′. Then, Party B verifies 370 the ‘user plus data’ authentication proof by using the received response cryptogram r, the challenge matrix C′, the tag t′, and the pre-shared secret key s′ to compute 262 weight w=∥C′·(t′⊕s′)⊕r∥₁. Party B then determines 374 to accept or reject the message based on a predefined acceptable authentication window for the value w (i.e., the authenticity and integrity of the data is authenticated if the computed weight w is within the acceptable authentication window and this is only possible if s=s′, T=T′, C=C′, and the message M sent is not modified). If w is smaller than the acceptable authentication window, then Party B (the Verifier) is convinced that message M is authentic and accepts the message M. Otherwise, the message M is rejected. Party B then sends 380 a ‘message okay’ or a ‘message not okay’ response to Party A.

In accordance with the present embodiments, the security of QKD is relied upon to guarantee both the randomness of the LPN challenge and tag matrices and to nullify the ability for any active attacker to influence or modify the matrices, while also reducing the communication overhead of sending the matrices. By using LPN as the cryptographic system instead of OTP or symmetric key cryptography or another method, new protocols for QKD user and data authentication in accordance with the present embodiments are added without the vulnerability of man-in-the-middle eavesdropping attacks. From a system security standpoint, the present embodiments anticipate and expect the need for user/message authenticity and integrity to be equal, if not more critical, than message confidentiality.

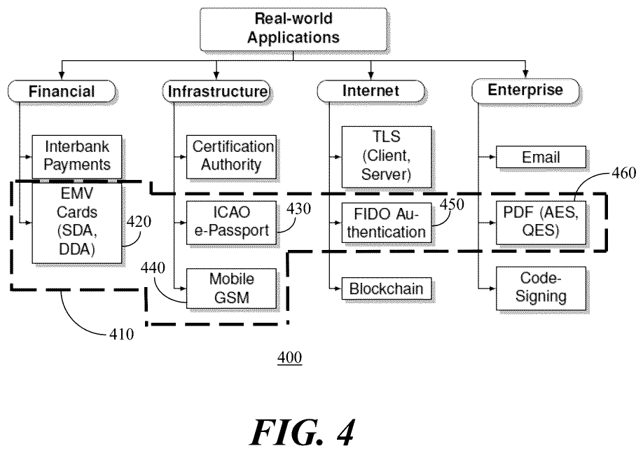

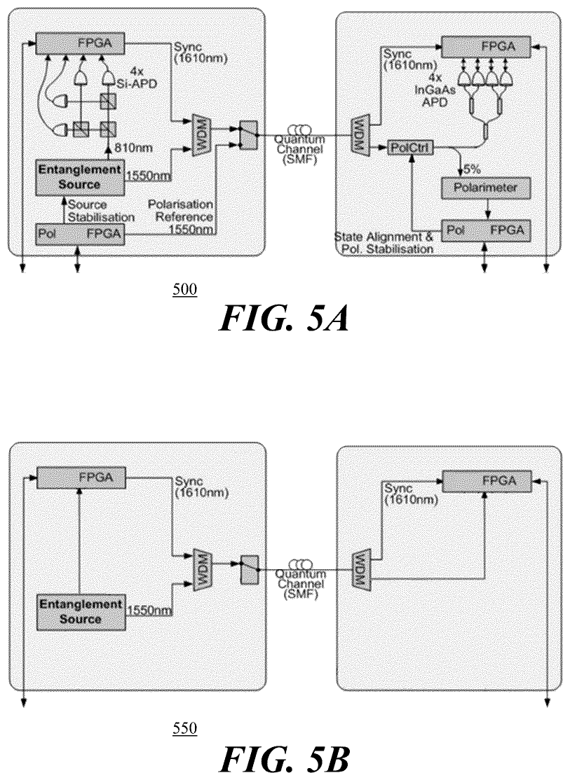

Digital signing algorithms are required for authentication in many real-world applications. Authentication in the post-quantum world will look to solutions such as Quantum Key Distribution. But, as discussed hereinabove, many such solutions will require the use of high-overhead, expensive QKD communications. FIG. 4 is a diagram 400 showing fourteen exemplary real-world applications across four broad categories where digital signing is required now and will be required in a post-quantum world. The categories chosen are financial (for the economy), critical infrastructure (for the government, people, and devices), internet (for business-to-business, business-to-consumer, peer-to-peer, and Internet-of-things interactions), and enterprise (for businesses). Several of these applications identified in the dashed box 410 use low resource devices such as chipcards which have the problems described hereinabove and would be in particular need of the methods and systems of the present embodiments.

For example, in the financial sector, EMV is a chip-based standard that is used for consumer payments. Consumers are provided with an EMV chip card that is used to pay for purchases at physical merchant stores, while merchants have specialized terminals that can read the EMV chip cards and obtain the necessary authentication and transaction authorization from the issuing banks via the payment networks. While the majority of the cryptographic algorithms used in EMV are symmetric key-based, EMV relies on asymmetric key digital signatures in static data authentication (SDA) and dynamic data authentication (DDA) protocols to reduce payment card fraud. Both EMV-SDA and EMV-DDA 420 rely on digital signing for authentication of the card by the merchant terminal using chip cards with low resource overhead requirements.

As another example, the International Civil Aviation Organization (ICAO) maintains the ICAO 9303 standard for machine-readable travel documents or e-Passports which is the officially recognized standard used today for identifying persons in all cross-border travel. The e-Passport contains a data page that includes both visual information as well as electronic information (including personal particulars, facial and fingerprint biometric, visa, authentication keys) about the person identified by the document embedded within a contactless chip card. The electronic information in the e-Passport is signed by a document signer key which is certified by the country signing certification authority (CSCA). While ICAO 9303 relies on digital signing to assert the integrity of the traveler's identity contained within the ICAO e-Passport 430, the contactless chip card in the document has low overhead resource requirements for authentication communication.

The Global System for Mobile communications Association (GSMA) is a trade grouping of technology vendors, network operators, and service providers that define, implement, and certify standards used for the modern-day mobile communication using handsets. Much of the security related to mobile communications use industry best practices including AES-128 bit encryption, SHA-256 hash and key derivation, and common criteria assurance level for subscriber identity module (SIM) and embedded SIM (eSIM) cards. Within the GSM eSIM standard where handsets can be dynamically provisioned with different profiles, digital signatures are used to provide mutual authentication between the mobile network operator (MNO) and the Universal Integrated Circuit Card (eUICC), a chip card equivalent that is embedded within the subscriber's handset. As Mobile GSM 440 eSIM relies on digital signing to ensure both MNO and eUICC are authenticated and eSIM cards are low-resource devices, such MNO-eUICC communication could beneficially use the systems and methods in accordance with the present embodiments,

Further, to reduce the reliance on passwords as the primary means of user authentication, the Fast Identity Online (FIDO) alliance proposed the Universal Authentication Framework (UAF) standard for FIDO Authentication 450 that replaces the use of a secret password with biometric authentication. The FIDO Server relies on digital signing to remotely authenticate the FIDO client to require quantum-level authentication for low resource devices.

The PDF Advanced Electronic Signature (PAdES) standard describes different levels of assurance for signed PDF documents. PDF documents signed using advanced electronic signatures (PDF-ABS) provide the assurance that the document has not been modified since it was signed, but not signer non-repudiation. Typical PDF-AES implementations use a document server in the backend to digitally sign the document with a common signing key protected by a HSM after authenticating the signer. For a higher level of assurance, qualified electronic signatures (PDF-QES) require the signer to be in possession of the private key used for signing and provides for non-repudiation in addition to document integrity. In PDF-QES 460 implementations, signers will be issued with a USB token to store the private key that is used for signing. PDF signing relies on digital signing to provide document integrity (for PDF-AES) and signer non-repudiation (for PDF-QES).

Referring to FIG. 5A, a diagram 500 depicts a structure of an exemplary QKD module in photonic communication along a QKD link with another similarly-structured QKD module. While there are various implementation structures of QKD modules, this particular structure is a QKD module for use in an entanglement-based QKD system. This QKD module is complex and costly as it provides circuitry for polarization of the photons and error correction to enable conventional QKD secure exchange of secret keys.

In accordance with the present embodiments, there is no need for the polarization of the photons. Thus, only the key quantum communication component, a Spontaneous Parametric Down Conversion (SPDC) component, is required along with the lightweight LPN algorithm to accomplish the user and data authentication described hereinabove. Referring to FIG. 5B, a diagram 550 depicts modified QKD modules which can support quantum-safe messaging for the authentication of users and data in accordance with the present embodiments which advantageously uses minimal cryptographic processing and small data overheads for lightweight post-quantum cryptographic communication between the modified QKD modules. Thus, QKD modules which only include the SPDC components can support quantum-safe messaging for the authentication of users and data between low-resource devices and can beneficially reduce the cost of the QKD system equipment and setup by more than seventy percent. In addition, the shared random established between the modified QKD modules in accordance with the present embodiments need not be secret which can lead to further cost savings in the QKD system equipment and setup.

The applications of the methods and systems in accordance with the present embodiments for quantum computing user and data authentication that are quantum-safe and less costly with lower overhead are limitless. Some examples include remote user-password verification, device-to-device secure messaging, and secure broadcasting. However, the use-cases of the methods and systems are not limited to these three exemplary use-cases described hereinafter.

Remote user-password verification is a user-authentication use-case where a user is expected to present a password during a login session to a remote service, and the service will verify the identity of the user in the process. This password can be made up of one or more of a pre-agreed secret, a limited-use code, or a derived value. A pre-agreed secret is a secret where only the user (or a defined group of users) and a service knows the secret. A limited-use code is a code limited by use and/or time which is sent from a service to a user. And a derived value is a value which can be computed using characteristics available to the user such as facial or fingerprint biometric values.

In the quantum future, users are expected to be equipped with quantum capable devices which can be in the form of computers, tablets, mobile phones, or similar devices. In such quantum capable devices and communication therebetween, it is envisioned that the methods and systems in accordance with the present embodiments may provide the following exemplary process for user login to a remote device. First, the user device with a corresponding QKD module will carry out QKD negotiations with a remote service's QKD module. User authentication will occur in a manner as discussed hereinabove in regards to the flow diagram 200 (FIG. 2) where the user is Party A and the remote service is Party B. First, the user's device obtains a password s from the user. Then the user's device retrieves the challenge matrix C from its QKD module and computes the cryptogram r=C·s⊕e, where e is the LPN noise vector. The cryptogram r is transmitted to the remote service along with any other information required for authentication and the remote service verifies r in accordance with the user authentication process of the present embodiments. First, the remote service retrieves the challenge matrix C′ from its QKD module. Then, the remote service retrieves the pre-agreed user's password s′ from its storage. Next, the remote service computes weight w=∥C′·s′⊕r∥₁ and if w is within an acceptable authentication window, the response is accepted and the user is allowed to login to the remote service.

Device-to-device secure messaging happens regularly amongst devices which are required to transmit status information, transaction logs, control commands, alerts, or similar information to keep the entire system operational and available. Any modifications to the messages or any fake messages injected can put the system in jeopardy. These devices could include programmable logic controllers (PLCs) in industrial control systems, smart vehicles in Internet-of-things (IoT) environments, electronic appliances in smart homes, or similar devices or systems which need to securely exchange information. Such devices will typically have some form of shared secrets amongst the devices which would advantageously enable use of authentication methods and systems in accordance the present embodiments to safely and securely exchange such information and prevent modifications to the information or fake messaging.

Where such devices would be quantum-enabled and have access to a QKD module, the following exemplary method or similar method would advantageously provide improved authentication in accordance with the methods and systems of the present embodiments. The QKD modules associated with the communicating devices will carry out QKD negotiations and data authentication (or ‘device plus data’ authentication) will occur in a manner as discussed hereinabove in regards to the flow diagram 300 (FIG. 3) where the user is Party A and the remote service is Party B. First, the sending device computes a hash m of message M (i.e., m=Hash(M)) which is meant to create a smaller fingerprint of the original message M, if the message M is too large to be used as the vector m. The sending device then retrieves the tag matrix T from its QKD module to compute the tag vector t as t=T·m. The sending device also retrieves the challenge matrix C from its QKD module to compute a response vector r as r=C·(t⊕s)⊕e where s is the shared secret and e is a LPN noise vector.

The response vector r is transmitted from the sending device to the receiving device along with the message M and any other information required and the receiving device verifies the response vector r before accepting the message M. To verify the response vector r and authenticate the message M, the receiving device computes a Hash m of the message M as m=Hash(M). Then the receiving device retrieves the tag matrix T′ from its QKD module to compute tag vector t′ as t′=T′·m and retrieves the challenge matrix C′ from its QKD module. The receiving device then computes a weight w as w=∥C′·(t′⊕s′)⊕r∥₁, where s′ is the shared secret. The message M is considered authenticated if w is within a predefined acceptable authentication window and, once authenticated, the receiving device proceeds to process message M.

Broadcasting or one-to-many communication is an important form of communication in many application scenarios. However, due to the point-to-point nature of QKD, supporting such communications has not been explored. The methods and systems in accordance with the present embodiments provide a secure broadcasting use-case where messages transmitted from a central hub and received by multiple spoke recipients can be protected from tampering, assuming that the central hub and the multiple spoke recipients already have some form of shared secrets amongst them.

In a quantum future where a transmitting hub and n receiving spokes each have access to their own QKD modules, the following secure broadcasting use-case can be enabled by the methods and systems in accordance with the present embodiments.

Initially, all QKD modules associated with the central hub and each of the receiving spokes will carry out mutual QKD negotiations with each other. This will result in every QKD module having n connections with other QKD modules. Thereafter, the authentication process in accordance with the present embodiments will resemble the process as discussed hereinabove in regards to the flow diagram 300 (FIG. 3) where the transmitting central hub is Party A and each of the n spokes receiving messages are Party B.

First, the transmitting central hub computes a hash m of message M (i.e., m=Hash(M)) to create a smaller fingerprint of the original message M if the message M is too large to be used as the vector m. Then, the transmitting central hub retrieves all of the tag matrices T₁, T₂, . . . , Tₙ from its QKD module to compute the tag matrix T=T₁⊕T₂⊕ . . . ⊕Tₙ and to compute the tag vector t as t=T·m. The transmitting central hub also retrieves all of the challenge matrices C₁, C₂, . . . , Cₙ from its QKD module to compute the challenge matrix C=C₁⊕C₂⊕ . . . ⊕Cₙ. The transmitting central hub then computes a response vector r as r=C·(t⊕s)⊕e where s is the shared secret and e is a LPN noise vector.

The response vector r is transmitted to all n receiving spokes along with the message M and any other information required and each of the n receiving spokes verifies the response vector r before accepting the message M. To verify the response vector r and authenticate the broadcast message M, each of the n receiving spokes performs the following steps: (a) the receiving spoke computes a Hash m of the message M as m=Hash(M); (b) then the receiving spoke retrieves all of the tag matrices

$${T}_{1}^{′} , {T}_{2}^{′} , … , {T}_{n}^{′}$$

from it QKD module to compute a tag matrix

$${T}^{′} = {T}_{1}^{′} ⊕ {T}_{2}^{′} ⊕ … ⊕ {T}_{n}^{′}$$

and then compute the tag vector t′ as t′=T′·m; (c) next the receiving spoke retrieves all of the challenge matrices

$${C}_{1}^{′} , {C}_{2}^{′} , … , {C}_{n}^{′}$$

from it QKD module to compute a challenge matrix

$${C}^{′} = {C}_{1}^{′} ⊕ {C}_{2}^{′} ⊕ … ⊕ {C}_{n}^{′} ;$$

and (d) the receiving spoke computes a weight w as w=∥C′·(t′⊕s′)⊕r∥₁, where s′ is the shared secret. The message M is considered authenticated if w is within a predefined acceptable authentication window and, once authenticated, the all of the n receiving spokes proceed to process broadcast message M.

We have presented a new design combining the QKD with LPN to achieve secure user and data authentication between communicating parties. The result is quantum-secure use-cases using lightweight protocols which are suitable for remote user-password verification, device-to-device secure messaging and secure broadcasting.

Thus, it can be seen that the present embodiments provide quantum-ready authentication methods and systems which advantageously and efficiently addresses existing and upcoming weaknesses in secure user and data authentication by combining the Quantum Key Distribution (QKD) with Learning Parity with Noise (LPN) to enable secure communication in many quantum use-cases. The result is methods and systems which provide robust protection against quantum-capable attackers and low computational and data overheads for low-resource device communications. Such methods and systems in accordance with the present embodiments provide quantum-secure use-cases using lightweight protocols which are suitable for, among other use-cases, remote user-password verification, device-to-device secure messaging and secure broadcasting.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the disclosure in any way. Rather, the foregoing detailed description will provide a convenient road map for implementing exemplary embodiments of the disclosure, it being understood that various changes may be made in the function and arrangement of steps and method of operation described in the exemplary embodiments without departing from the scope of the disclosure as set forth in the appended claims.

1. A quantum-capable secure user and data authentication system comprising:
a first communication device;
a first key distribution module communicatively coupled to the first communication device for secure communication therewith;
a second communication device; and
a second key distribution module communicatively coupled to the second communication device for secure communication therewith,
wherein the first communication device and the second communication device enable quantum-safe authentication therebetween while a key distribution protocol between the first key distribution module and the second key distribution module is utilized to establish a shared random between the first communication device and the second communication device, and wherein the first communication device and the second communication device have established a pre-agreed secret password and utilize the pre-agreed secret password and the shared random for the quantum-safe authentication therebetween.

2. The system in accordance with claim 1 wherein the quantum-safe authentication utilizes Learning Parity with Noise (LPN) post-quantum cryptography.

3. The system in accordance with claim 2 wherein the LPN post-quantum cryptography comprises a Hopper-Blum protocol.

4. The system in accordance with claim 1 wherein either or both of the first key distribution module and the second key distribution module comprise a SPDC photonic communication module for the key distribution protocol therebetween.

5. The system in accordance with claim 1 wherein either or both of the first key distribution module and the second key distribution module comprise a Quantum Key Distribution (QKD) module, and wherein the key distribution protocol between the first key distribution module and the second key distribution module comprises QKD protocol.

6. The system in accordance with claim 1 wherein the first key distribution module is communicatively coupled to the first communication device via a secure Application Programming Interface (API), and wherein the second key distribution module is communicatively coupled to the second communication device via a secure API.

7. The system in accordance with claim 1 wherein the shared random comprises a first challenge matrix.

8. The system in accordance with claim 7 wherein the first communication device generates a response cryptogram based on the first challenge matrix and the pre-agreed secret password and sends the response cryptogram to the second communication device.

9. The system in accordance with claim 8 wherein the first communication device further generates the response cryptogram based on randomly-generated noise of a pre-defined probability.

10. The system in accordance with claim 8 wherein the second communication device authenticates the first communication device in response to the response cryptogram, a second challenge matrix derived from the shared random and the pre-agreed secret password.

11. The system in accordance with claim 10 wherein the second communication authenticates the first communication device if a weight determined based on the response cryptogram, the second challenge matrix and the pre-agreed secret password is within a predefined acceptable authentication window.

12. The system in accordance with claim 9 wherein the first communication device further generates the response cryptogram based on a tag vector, and wherein the tag vector is determined in response to a hash value of a message to be sent from the first communication device to the second communication device.

13. The system in accordance with claim 12 wherein the tag vector is further determined in response to the hash value of the message to be sent from the first communication device to the second communication device and a tag matrix, wherein the quantum-safe authentication further includes the first key distribution module and the second key distribution module sharing the tag matrix therebetween.

14. The system in accordance with claim 12 wherein, after the message is sent from the first communication device and received at the second communication, the second communication device authenticates the first communication device and the message in response to the response cryptogram, a second challenge matrix derived from the shared random, the tag vector, and the pre-agreed secret password.

15. The system in accordance with claim 14 wherein the second communication authenticates the first communication device and the message if a weight determined based on the response cryptogram, the second challenge matrix, the tag vector, and the pre-agreed secret password is within a predefined acceptable authentication window.

16. A method for quantum-capable secure user and data authentication in a system including a first communication device communicatively coupled to a first Quantum Key Distribution (QKD) module and a second communication device communicatively coupled to a second QKD module, wherein the first communication device and the second communication device are communicatively coupled across a first communication path, the method comprising:
the first communication device and the second communication device establishing a pre-agreed secret password therebetween; and
the first communication device and the second communication device enabling quantum-safe authentication therebetween in response to lightweight communication between the first QKD module and the second QKD module to establish a shared random therebetween.

17. The method in accordance with claim 16 wherein the quantum-safe authentication utilizes Learning Parity with Noise (LPN) post-quantum cryptography.

18. (canceled)

19. The method in accordance with claim 16 wherein the shared random comprises a first challenge matrix.

20. The method in accordance with claim 19 wherein the first communication device and the second communication device enabling quantum-safe authentication therebetween comprises:
the first communication device generating a response cryptogram based on the challenge matrix and the pre-agreed secret password; and
the first communication device sending the response cryptogram to the second communication device.

21. The method in accordance with claim 20 wherein the first communication device and the second communication device enabling quantum-safe authentication therebetween further comprises the first communication device generating the response cryptogram based on randomly-generated noise of a pre-defined probability.

22-27. (canceled)
